(19) United States
(12) Patent Application Publication
(10) Pub. No.: US 2018/0101986 A1
(43) Pub. Date: Apr. 12, 2018

(54) DRAWING IN A 3D VIRTUAL REALITY ENVIRONMENT

(71) Applicants: Aaron Mackay Burns, Newcastle, WA (US); Donna Katherine Long, Redmond, WA (US); Matthew Steven Johnson, Kirkland, WA (US); Benjamin J. Sugden, Redmond, WA (US); Bryant Daniel Hawthorne, Duvall, WA (US)

(72) Inventors: Aaron Mackay Burns, Newcastle, WA (US); Donna Katherine Long, Redmond, WA (US); Matthew Steven Johnson, Kirkland, WA (US); Benjamin J. Sugden, Redmond, WA (US); Bryant Daniel Hawthorne, Duvall, WA (US)

(21) Appl. No.: 15/289,523

(22) Filed: Oct. 10, 2016

(51) Int. Cl. G06T 19/00; G06T 11/20; G06F 3/01; G06T 15/20; G06T 19/20; G06F 3/0484; G06F 3/0346; G06F 3/0481

(52) U.S. Cl. CPC G06T 19/006; G06T 11/203; G06F 3/013; G06T 15/20; G06F 3/0482; G06F 3/04842; G06F 3/0346; G06F 3/04815; G06T 2210/21; G06T 19/20

(57) ABSTRACT

In various implementations, methods and systems for drawing in a three-dimensional (3D) virtual reality environment are provided. An intersection between a user input and an object, associated with a three-dimensional (3D) virtual reality environment is identified. An anchor position is determined for a drawing surface based on the identified intersection. A gaze direction of a user in the 3D virtual reality environment is identified. A drawing surface configuration for the drawing surface with respect to the 3D virtual reality environment is determined based on the gaze direction, where the drawing surface configuration indicates how the drawing surface is defined in the 3D virtual reality environment. The drawing surface is defined in the 3D virtual reality environment at the determined anchor position with the determined drawing surface configuration. A drawing is generated on the drawing surface based on drawing input.

### BACKGROUND

Virtual reality devices, such as head-mounted virtual reality devices, may be used in a variety of real and/or virtual world environments and contexts. Augmented reality devices are types of virtual reality devices that can support direct or indirect views of a real world environment along with augmented reality objects digitally projected on the real world scene. Augmented reality devices can also operate as scene-aware devices that have an understanding of a real world environment defined as an augmented reality environment (i.e., virtual environment) supported by the augmented reality device. An augmented reality device can support presentation the of the augmented reality objects, which are virtualized entities (e.g., holographic content or mixed-reality content), that are rendered for a user associated with the augmented reality device. The augmented reality objects can be rendered based on the real world environment captured by the augmented reality device.

### SUMMARY

Embodiments of the present invention are directed to drawing in a three-dimensional (3D) virtual reality environment. In various embodiments, when a user wishes to draw in a 3D virtual reality environment, a drawing surface is defined at a position based on an object associated with the 3D virtual reality environment and with an orientation facing the user's gaze direction. The user can draw on the drawing surface, such as to annotate the object. For example, drawing input from the user may be locked to the drawing surface. This allows for a more natural drawing experience for users than free-form 3D drawing.

In some respects, a user is able to direct user input to an object associated with a 3D virtual reality environment, which may be a virtual object or a real object. This may be accomplished using a free space pointer device, a Six degrees of freedom (6DoF) input device, or other user input device. An anchor position for a drawing surface is determined based on the object. In some cases, this includes casting (e.g., raycasting or spherecasting) user input into the 3D virtual reality environment (e.g., casting from a real or virtual cursor controlled by the user) and detecting an intersection between the casted user input and the object. The anchor position can be determined based on the detected intersection such as based on a collision point of the casted user input with the object. The drawing surface can be defined at the anchor position and the user can draw on the drawing surface using a drawing interface.

In further respects, a drawing surface configuration can be determined for the drawing surface with respect to the 3D virtual reality environment. This can include an orientation of the drawing surface in the 3D virtual reality environment. The orientation may be based on the gaze direction of a user. In some cases, the orientation is determined such that the drawing surface faces the user (e.g., such that a normal of the drawing surface points in the gaze direction).

In some aspects of the present disclosure, the drawing surface configuration includes a shape of the drawing surface. A shape may be determined automatically based on user context or explicitly selected by a user. In some cases, the drawing surface is a two-dimensional (2D) plane. In other cases, the drawing surface is a composite surface determined based on a shape of the object. This could include a plane merged with at least some of the shape of the object. In some cases, drawing surface comprises a convex region and/or a concave region. A concave drawing surface may be suitable for an individual user so the user can pivot his or her head while maintaining a clear view of drawings. A convex drawing surface may be suitable for multiple users so each user may clearly view drawings from different angles. Thus, in some cases, a convex region is included in a drawing surface based on identifying a solo mode for drawing. Further, a convex region may be included in a drawing surface based on identifying an accompanied mode for drawing.

In accordance with additional aspects of the present disclosure, a user may direct spatial input away from the drawing surface. Based on detecting this spatial input (e.g., based on a distance between a cursor and the drawing surface), drawing on the drawing surface may be terminated. This may include disabling a lock of a drawing interface on drawing input to the drawing surface. In some cases, based on detecting this spatial input, the drawing interface is transitioned to a free-form drawing 3D drawing mode. As another example, based on detecting this spatial input, the drawing interface could shift the lock to another existing or new drawing surface.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is an illustration of an exemplary implementation of a 3D graphical visualization system, in accordance with embodiments of the present invention;

FIG. 2A is an illustration of an exemplary implementation of a user initiating drawing on a drawing surface, in accordance with embodiments of the present invention;

FIG. 2B is an illustration of an exemplary implementation of a user drawing on a drawing surface, in accordance with embodiments of the present invention;

FIG. 3 is an illustration of an exemplary implementation of a user drawing on a drawing surface, in accordance with embodiments of the present invention;

FIG. 4 is an illustration of an exemplary implementation of a user drawing on a drawing surface, in accordance with embodiments of the present invention;

FIG. 5A is an illustration of an exemplary implementation of a user directing user input away from a drawing surface, in accordance with embodiments of the present invention;

FIG. 5B is an illustration of an exemplary implementation of a switch from a locked drawing mode to a free space drawing mode, in accordance with embodiments of the present invention;

FIG. 5C is an illustration of an exemplary implementation of a switch of a lock on drawing input from one drawing surface to another drawing surface, in accordance with embodiments of the present invention;

FIG. 6 is a flow diagram showing a method in accordance with embodiments of the present invention;

FIG. 7 is a flow diagram showing a method in accordance with embodiments of the present invention;

FIG. 8 is a block diagram of an exemplary head-mounted display device, in accordance with embodiments of the present invention; and

FIG. 9 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Virtual reality devices, such as head-mounted virtual reality devices, may be used in a variety of real and/or virtual world environments and contexts. In some applications, it would be desirable to allow users to produce drawings and other graphical compositions in a 3D virtual reality environment. Examples of such applications include meeting or presentation applications and the design and discussion of physical and/or virtual objects. However, drawing in a 3D virtual reality environment on a mixed or virtual reality device is difficult for many users. In some approaches, a user can draw in free space where 3D movement by the user is directly translated into drawing. However, some users have difficulty judging depth, which can lead to unpredictable results in some cases.

Embodiments of the present disclosure are directed to approaches to drawing in a 3D virtual reality environment that apply more intuitive 2D drawing paradigms to 3D virtual space. In various embodiments, when a user wishes to draw in a 3D virtual reality environment, a drawing surface is defined at a position based on an object associated with the 3D virtual reality environment and with an orientation facing the user's gaze direction. The user can draw on the drawing surface, such as to annotate the object. For example, drawing input from the user may be locked to the drawing surface. This allows for a more natural drawing experience for users than free-form 3D drawing.

In some respects, a user is able to direct user input to an object associated with a 3D virtual reality environment, which may be a virtual object or a real object. This may be accomplished using a free space pointer device, a Six degrees of freedom (6DoF) input device, or other user input device. An anchor position for a drawing surface is determined based on the object. In some cases, this includes casting (e.g., raycasting or spherecasting) user input into the 3D virtual reality environment (e.g., casting from a real or virtual cursor controlled by the user) and detecting an intersection between the casted user input and the object. The anchor position can be determined based on the detected intersection such as based on a collision point of the casted user input with the object. The drawing surface can be defined at the anchor position and the user can draw on the drawing surface using a drawing interface.

In further respects, a drawing surface configuration can be determined for the drawing surface with respect to the 3D virtual reality environment. This can include an orientation of the drawing surface in the 3D virtual reality environment. The orientation may be based on the gaze direction of a user. In some cases, the orientation is determined such that the drawing surface faces the user (e.g., such that a normal of the drawing surface points in the gaze direction).

In some aspects of the present disclosure, the drawing surface configuration includes a shape of the drawing surface. A shape may be determined automatically based on user context or explicitly selected by a user. In some cases, the drawing surface is a 2D plane. In other cases, the drawing surface is a composite surface determined based on a shape of the object. This could include a plane merged with at least some of the shape of the object. In some cases, drawing surface comprises a convex region and/or a concave region. A concave drawing surface may be suitable for an individual user so the user can pivot his or her head while maintaining a clear view of drawings. A convex drawing surface may be suitable for multiple users so each user may clearly view drawings from different angles. Thus, in some cases, a convex region is included in a drawing surface based on identifying a solo mode for drawing. Further, a convex region may be included in a drawing surface based on identifying an accompanied mode for drawing.

In accordance with additional aspects of the present disclosure, a user may direct spatial input away from the drawing surface. Based on detecting this spatial input (e.g., based on a distance between a cursor and the drawing surface), drawing on the drawing surface may be terminated. This may include disabling a lock of a drawing interface on drawing input to the drawing surface. In some cases, based on detecting this spatial input, the drawing interface is transitioned to a free-form drawing 3D drawing mode. As another example, based on detecting this spatial input, the drawing interface could shift the lock to another existing or new drawing surface.

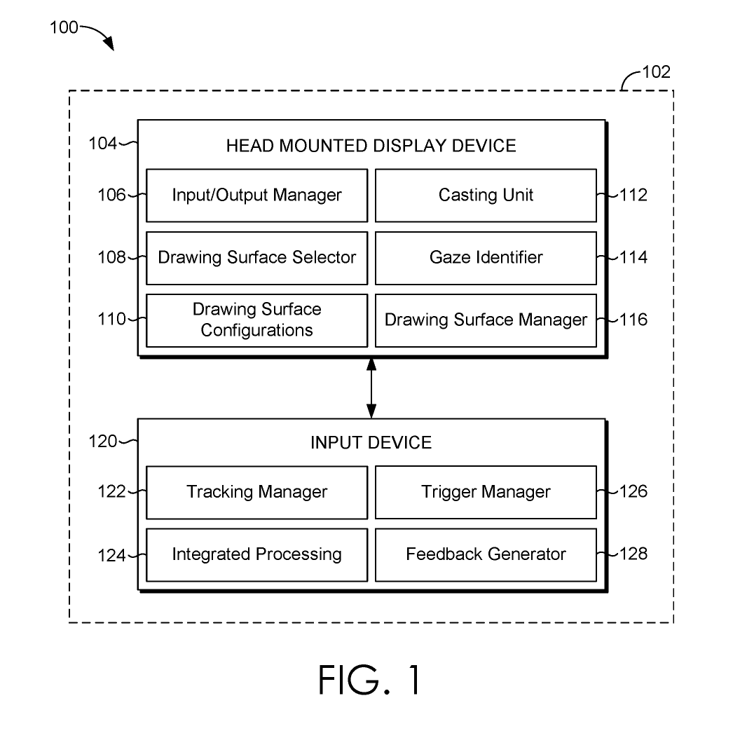

With reference to FIG. 1, embodiments of the present disclosure are discussed with reference to exemplary 3D graphical visualization system 100 that is an operating environment for implementing functionality described herein. 3D graphical visualization system 100 includes 3D graphical visualization mechanism 102 comprising head mounted display (HMD) 104 and input device 120.

By way of example, as shown in FIG. 1, HMD 104 includes input/output (I/O) manager 106, drawing surface selector 108, drawing surface configurations 110, casting unit 112, gaze identifier 114, and drawing surface manager 116. Also by way of example, input device 120 includes tracking manager 122, integrated processing 124, trigger manager 126, and feedback generator 128.

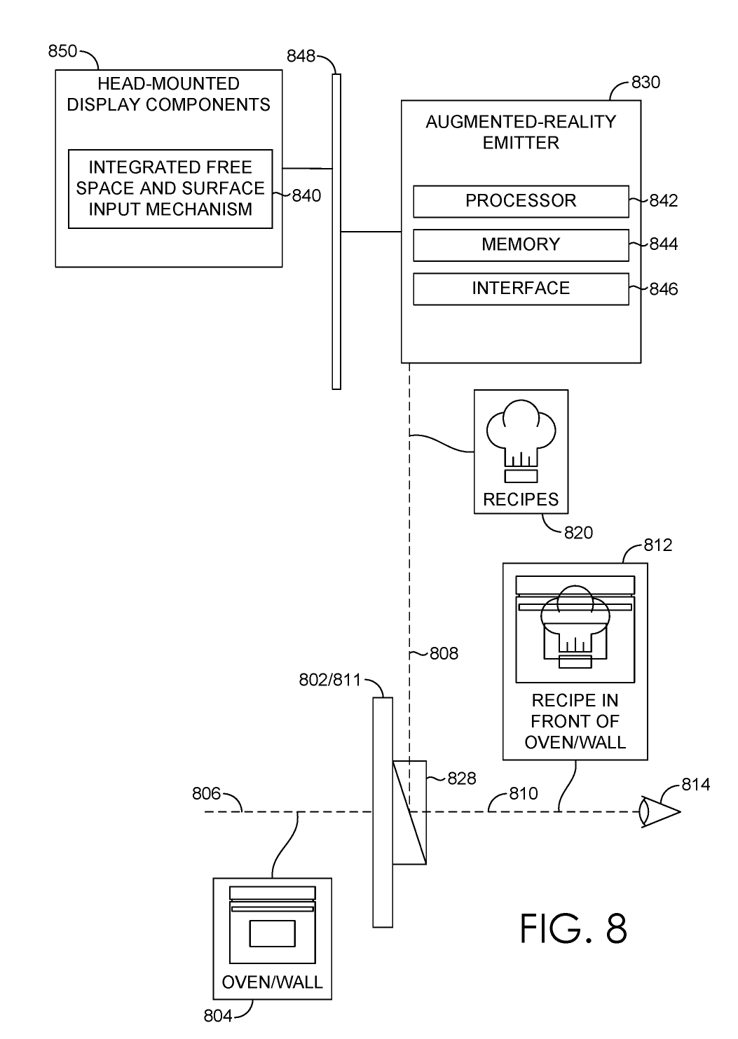

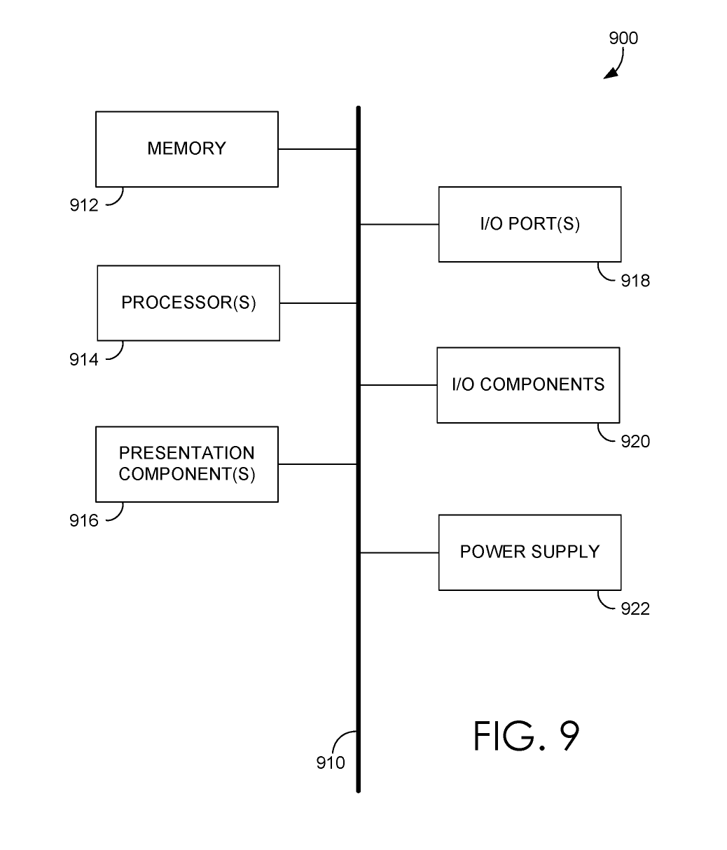

HMD 104 can include any type of HMD or virtual reality device, such as an augmented reality device, including those described below with reference to FIGS. 8 and 9. For discussion purposes only, the virtual reality device is an exemplary HMD 104, but other types of virtual reality devices are contemplated for embodiments of the present disclosure. Input device 120 can be any type of input device, such as a free space input device, a 6DoF input device, a joystick, a touch surface (e.g., touch screen display), a mouse, a keyboard, a pen-like or wand-like controller, or any suitable combination thereof.

As an overview, in some embodiments, HDM 104 receives input (e.g., using I/O manager 106) from, for example, input device 120 in order to identify an object(s) associated with a 3D virtual reality environment. HDM 104 can determine (e.g., using casting unit 112) an anchor position for a drawing surface based on the identified object and determine (e.g., using gaze identifier 114 and drawing surface selector 108) a drawing surface configuration for the drawing surface (e.g., shape, orientation, etc.) with respect to the 3D virtual reality environment. HMD 104 can further define (e.g., using drawing surface manager 116) the drawing surface in the 3D virtual reality environment at the anchor position with the determined drawing surface configuration. Using input device 120 or another form of input (e.g., from another input device or combination of input devices or inputs), a user can draw on the drawing surface. The drawing input from the user may be locked to the drawing surface (e.g., by drawing surface manager 116). Locking the drawing input to the drawing surface may cause the drawing input to be referenced to the drawing surface, such that the drawing is generated or positioned in the 3D virtual reality environment relative to the drawing surface.

In the present example, HMD 104 is a scene-aware device that understands elements surrounding a real world environment and generates virtual objects to display as augmented reality images to a user. HMD 104 can be configured to capture the real world environment based on components of HMD 104. To this effect, HMD 104 can include a depth camera and/or other sensors that support understanding elements of a scene or environment, for example, by generating a 3D mesh representation of a real world environment. This 3D mesh representation of a real world environment can correspond to one suitable 3D virtual reality environment utilized in implementations of the present disclosure. In other cases, the 3D virtual reality environment is completely synthetic, such as in implementations where HMD 104 does not support augmented reality.

HMD 104 can include an augmented reality emitter, such as augmented reality emitter 830 of FIG. 8 for projecting virtual objects or images in the real world based at least in part on the 3D mesh representation. In this regard, HMD 104 can support augmented reality or mixed-reality experiences using input device 120. A mechanism as used herein refers to any device, process, or service or combination thereof. A mechanism may be implemented using components implemented as hardware, software, firmware, a special-purpose device, or any combination thereof. A mechanism may be integrated into a single device or it may be distributed over multiple devices. Each device may correspond to any type of computing device described below with reference to FIG. 9. The various components of a mechanism may be co-located or distributed. The mechanism may be formed from other mechanisms and components thereof.

The components of 3D graphical visualization mechanism 102 may thus be reconfigured from what is shown in FIG. 1. Therefore, it should be appreciated 3D graphical visualization mechanism 102 depicts one exemplary configuration of the mechanism; however, any suitable mechanism may be employed for corresponding implementations of the disclosure. In some cases, 3D graphical visualization mechanism 102 could correspond to a single device. As another example, 3D graphical visualization mechanism 102 may not include a head mounted display device (e.g., another type of display device could be employed). Further, any of the various functionality of 3D graphical visualization mechanism 102 could be performed at least partially on a different device. In some cases, HMD 104 and input device 120 could be a single device.

I/O manager 106 directs inputs to HMD 104, such as inputs from one or more input devices (e.g., input device 120) and/or from the real world environment. Inputs from the real world environment can be captured by components of HMD 104 including cameras, sensors, and the like. I/O manager 106 also directs outputs from HMD 104, such as outputs to one or more devices (e.g., input device 120) and/or components of I/O manager 106 including projectors, displays, actuators, speakers, and the like.

Inputs to I/O manager 106 can be from tracking manager 122 of input device 120 (e.g., over a wired and/or wireless interface). Input device 120 and the components thereof correspond to a suitable example of an input device, but other configurations are possible. Further, it will be appreciated that one to all of the functions of input device 120 may be integrated into HMD 104.

Input device 120 can include, as examples, a free space tracking component and/or a surface tracking component. Input device 120 can be controlled by a user to generate free space input and/or surface input for HMD 104. The input is generated based on the free space tracking component and surface tracking component determining free space movement data and surface movement data respectively.

Integrated processing 124 processes the free space input or surface input based on referencing movement data. In some implementations, processing the free space input or surface input is based on referencing movement data transitioning from the free space input to the surface input or transitioning from the surface input to the free space input. The transition can be identified and used to generate appropriate output for controls of the interface. Integrated processing 124 communicates the output to I/O manager 106 of HMD 104 where the output can be used to control HMD 104.

Tracking manager 122 is responsible for tracking movement associated with input device 120. The free space tracking component and the surface tracking component may implement different coordinate spaces that are used to understand the movement in free space and on a surface respectively. Coordinate space can indicate how the movement data is represented. In some embodiments, the coordinate spaces are integrated to understand the motion in free space and on a surface together. The coordinate spaces can be used to determine movement data in free space and movement data on a surface that are communicated using integrated processing 124.

Tracking manager 122 can include or be associated with hardware components (e.g., sensors and cameras) that facilitate tracking the movement data. By way of example, the free space tracking component can be implemented using an inertial measurement unit (IMU) and cameras that are built into input device 120. The IMU is an electronic device that measures and reports motion attributes of the input device. The IMU can measure and report input device 120 specific force, angular rate and magnetic field based on a combination of accelerometers and gyroscopes, and magnetometers. The IMU can operate as an orientation sensor in free space. In this regard, the input device can be tracked based on multiple degrees of freedom. The input device 120 movement can be tracked in 3D space as free space movement data based on the coordinate space of the free space tracking. When a user moves the input device in space the movement is captured as movement data that can be communicated as output to HMD 104.

With reference to the surface tracking component, surface movement can be detected using a mechanical device (e.g., trackball) and/or using an optical tracker. For example, movement relative to a surface can be based on a light source (e.g., light emitting diode (LED)). The input device movement can be tracked in 2D space based on the coordinate space of 2D tracking. 2D and 3D coordinate spaces can be tracked independently and in combination as needed to provide functionality described herein.

Integrated processing 124 in addition to processing signals from tracking manager 122, integrated processing 124 can process communications to or from other internal or external components, which may include trigger input, pressure input and feedback output. Trigger manager 126 is responsible for processing input based on buttons, switches, joysticks and/or other triggers of input device 120 to provide the trigger input. Trigger manager 126 can detect the different types of trigger inputs from input device 120 to communicate trigger data or signals to integrated processing 124. This can include processing input based on pressure associated with input device 120 (e.g., the triggers thereof) and can be associated with a pressure sensor(s) that measures and reports pressure data.

Input device 120 can also operate with touch-sensitive interfaces that either replace or operate in combination with the trigger buttons. The touch-sensitive interfaces can include components that are built into or are independent of input device 120. For example, a touchpad component or device can be associated with input device 120. The touchpad includes a tactile sensor that can specifically operate as a specialized surface that can translate motion and position relative to the surface. A touchscreen electronic visual display can also operate with input device 120 to receive inputs via the touchscreen. A user can use their fingers on the touch-sensitive interfaces to provide touch input. Any of the various inputs and/or combinations thereof can be used to provide specifically defined controls for a graphical user interface on HMD 104.

Feedback generator 128 is responsible for generating feedback for a user on input device 120, which can include haptic feedback, audible feedback, visual feedback, or any combination thereof. Haptic feedback can refer to the application of forces, vibrations or motions at input device 120 to recreate a sense of touch. Feedback generator 128 may generate the feedback at the direction of I/O manager 106, as will later be described in further detail.

As mentioned above, HDM 104 can utilize input from I/O manager 106 to identify an object(s) associated with a 3D virtual reality environment. The object will be referred to in singular form, but it should be appreciated that the description applies to embodiments where the object corresponds to multiple objects.

In some implementations, HDM 104 identifies the object based on a user selecting the object using HDM 104 and/or at least one input device such as input device 120. The user may select an object using any suitable mechanism. As an example, the user may select the object using a graphical interface associated with display of the object (i.e., by providing inputs to the interface). This can include, as examples, any combination of the user gazing at the object, moving a physical and/or virtual cursor towards the object, and pointing a physical and/or virtual cursor towards the object. It is noted that as used herein, a user can refer to a user wearing a HMD, contacting the virtual reality device, and/or detectable by the virtual reality device. Any determinations made by 3D graphical visualization mechanism 102 described herein as being based on a user can be based on one or more of any combination of these types of users (e.g., gaze direction of one or more users, inputs from one or more users, etc.). Furthermore, in methods described herein determinations may be based on a different user(s) for different portions of the method.

Where a cursor is employed, HDM 104 can identify an object based on a position of the cursor (in real and/or virtual space) with respect to the object. An example of a physical cursor includes input device 120 when a position of input device 120 in space corresponds to a point or region of the 3D virtual reality environment that will be affected by input from the user. For example, a user may select one object by pointing input device 120 at or at least proximate the object (as perceived by or from a perspective of the user), or select another object by pointing input device 120 at or at least proximate the other object (as perceived by or from a perspective of the user). As another example, a finger, hand, arm, or other physical portion of a person or persons could be used as a physical cursor similar to input device 120.

An example, of a virtual cursor includes a moveable indicator displayed with respect to the 3D virtual reality environment (e.g., superimposed over or integrated into). Examples of virtual cursors include 2D and/or 3D GUI control elements, such as mouse cursors, gaze direction indicators, crosshairs, arrows, pointers, and the like. Movement of a virtual cursor may correspond to free space and/or surface input, as described above.

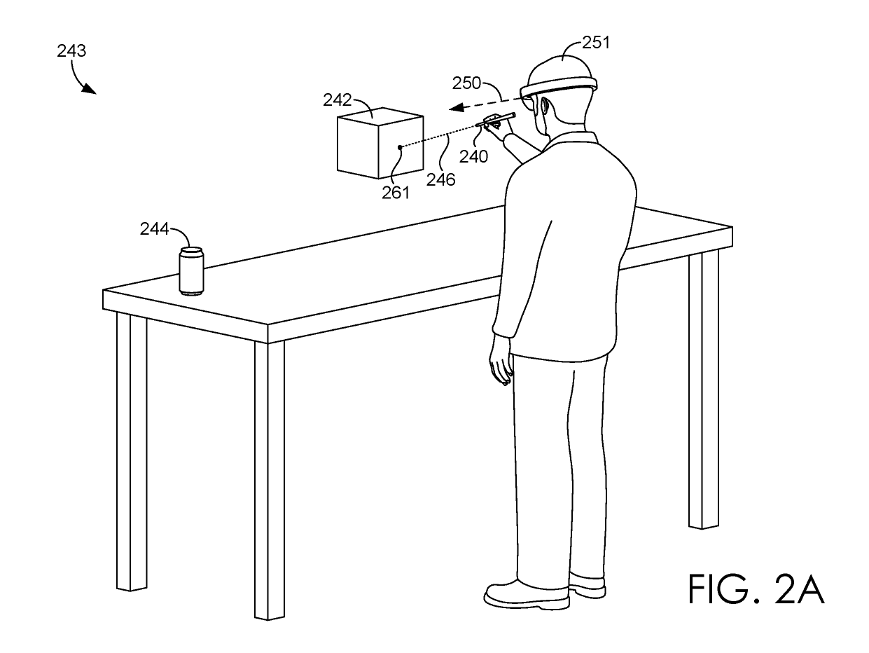

FIG. 2A is an illustration of an exemplary implementation of a 3D graphical visualization system, in accordance with embodiments of the present invention. By way of example, FIG. 2A shows virtual cursor 240, which can correspond to a virtual cursor described above. Virtual cursor 240 is configured to point into the 3D virtual reality environment as perceived by or from a perspective of the user. In this example, using input device 220, corresponding to input device 120 of FIG. 1, user 251 can provide input to input device 220 to manipulate where virtual cursor 240 is pointing with respect to the 3D virtual reality environment.

In the example, shown, the user is pointing virtual cursor 240 at object 242, which is a virtual object positioned within the 3D virtual reality environment, in the present example. However, instead, object 242 could be a real object, such as object 244. The user can select an object amongst any of various objects by pointing virtual cursor 240 at the object. In implementations where a physical cursor is employed in addition to or instead of a virtual cursor, similar description applies to the physical cursor as the virtual cursor.

In some implementations, HMD 104 identifies the object using casting unit 112 of FIG. 1. By way of background, casting techniques are used to understand and make meaning of elements in multi-dimensional virtual environments. For example, ray casting (or tracing) can be used to determine if a first object is intersected by a ray, or sphere casting can be used to determine if a first object is intersected by a sphere. Casting unit 112 is configured to perform casting operations to determine intersections in a 3D virtual reality environment. In one exemplary implementation, the casting unit may be configured to translate user input to a corresponding object in the 3D virtual reality environment. This can include casting the user input into the 3D virtual reality environment and identifying an intersection between the casted user input and the object. The object can be selected based on the identified intersection. For example, casting unit 112 can detect a collision between the casted user input and the object to identify the intersection. In one suitable approach, the casting comprises ray casting where the intersection corresponds to a collision between a ray and the object (e.g., a surface of the object). As another example, sphere casting may be employed where a sphere is casted and the intersection corresponds to a collision between a sphere and the object.

In order to cast user input, casting unit 112 may optionally determine a position in the 3D virtual reality environment to cast from. In some cases, casting unit 112 determines the position based on a position of the virtual and/or physical cursor. In addition, or instead, the position could be based on a gaze direction of a user and/or other user input, such as a touch location on a touch surface. Furthermore, casting unit 112 may optionally determine a direction in the 3D virtual reality environment to cast to. Casting unit 112 can determine the direction based on a position of the virtual and/or physical cursor. For example, the direction may be determined based on where the cursor(s) is pointing with respect to the 3D virtual reality environment. In other examples, the direction is a default direction, for example, pointing away from the user with respect to the 3D virtual reality environment. Optionally, HMD 104 may visually indicate to the user which object is currently selected.

Returning to the example of FIG. 2A, casting unit 112 has generated a visual representation of a casted user input 246 based on user input from user 251. It is contemplated that a visual representation of the casted user input is only exemplary and is not meant to be limiting to other visual representations of casted user input. The starting position of casted user input 246 corresponds to a location of virtual cursor 240 in the 3D virtual reality environment, and the direction of casted user input 246 is based on where virtual cursor 240 is pointing with respect to the 3D virtual reality environment. HMD 104 identifies object 242 based on detecting a collision between casted user input 246 and object 242.

It should be appreciated that a user may select and/or identify the object using any suitable input, examples of which have been described above. Also, in some cases, casting the user input may not be required. As one example, the user could select an object using voice commands by referencing one or more objects detectable by HMD 104. Thus, in FIG. 2A, the user could say “select controller.” Using language processing (e.g., natural language processing) HMD 104 could identify object 242 as corresponding to the voice input. For example, HMD 104 could match the input to metadata associated with object 242 defining a type of object (e.g., controller).

In addition, or instead, gaze direction can be utilized by HMD 104 as a user input received by I/O manager 106 to, at least partially, identify the object, such as object 242 (e.g., to determine the object is selected by the user). In these cases, the position and/or direction of the casted user input can be based on the gaze direction determined by gaze identifier 114. For example, the position may be based on a location of a user's head and the gaze direction can be used as or to determine the direction to cast the user input.

The gaze direction may be identified by gaze identifier 114 configured to identify and/or determine a gaze direction of a user of HMD 104 and/or other users perceptible by any of the various sensors of HMD 104. A gaze of a user can be determined using any suitable mechanism. In order to determine gaze direction 250 of user 251 in FIG. 2A, for example, gaze identifier 114 can process any of various sensor data available to HMD 104 including cameras, accelerometers, gyroscopes, and the like. The gaze direction of a user generally represents where the user is looking.

HMD 104 is configured to define at least one drawing surface based on the user input corresponding to the object. To this effect, drawing surface selector 108 can determine an anchor position for a drawing surface based on the user input. Further, drawing surface selector 108 can determine a drawing surface configuration for the drawing surface.

The anchor position corresponds to a position in which to define the drawing surface in the 3D virtual reality environment. For example, the anchor position can correspond to at least one 3D point in the 3D virtual reality environment. For example, a central point of the drawing surface could be positioned at an anchor point. In general, an anchor position can define where a user is to perceive the drawing surface as being located in the 3D virtual reality environment. In the example of FIG. 2A, the anchor point corresponds to an intersection or collision location (e.g., a point) between casted user input 246 and object 242.

In addition, or instead, the anchor position can be based on a gaze direction of a user. For example, as described above, in some cases, the casted user input corresponds to a gaze direction. However, even in cases where casted gaze direction is not utilized to identify an object, gaze direction can be employed to determine an anchor position with respect to the object (e.g., by casting into the gaze direction and basing the anchor position on the collision or intersection position with the object).

In some cases, an anchor position is independent of a collision position or intersection of user input. For example, the anchor position could be defined by metadata associated with the object. As an example, the metadata could define a default anchor position and drawing surface selector 108 may use or base the anchor position for the drawing surface on the default anchor position. As another example, a combination of the metadata of an object and user input could be used to determine an anchor position. Using metadata of objects, different objects, or types of objects, can have different anchor positions to result in the most appropriate anchor position for a particular object, even in cases where casted user input is used to determine the anchor positions.

The drawing surface configuration for the drawing surface selected by drawing surface selector 108 generally defines the drawing surface with respect to the 3D virtual reality environment and can correspond to one of drawing surface configurations 110. A drawing surface configuration describes how the drawing surface is to be defined in the 3D virtual reality environment. One or more portions of a drawing surface configuration can be predefined or can be generated based on rules such as user context associated with the selection of the drawing surface configuration, metadata of the object, and more.

Examples of features that can be determined for and/or defined by a drawing surface configuration for a drawing surface include one or more of a shape for the drawing surface, an orientation for the drawing surface in the 3D virtual reality environment, and a rendering mode for the drawing surface.

With respect to an orientation for a drawing surface, the orientation can be based on the identified object, a location of at least one user, and/or a gaze direction of at least one user. For example, drawing surface selector 108 can calculate the orientation for a drawing surface based on a location of a user with respect to the object, which can include utilizing the gaze direction of the user. As one example, the orientation could be calculated such that the drawing surface faces the gaze direction. In one approach, the orientation is determined such that a normal of the drawing surface will point in the gaze direction. In addition to or instead of location or gaze based determinations, the orientation could be determined based on determining a normal of the object. For example, a normal of the drawing surface could be set to be perpendicular with a normal of the object. Generally, the orientation can be determined using any suitable factor or combinations thereof, including one or more characteristics of the object and/or user(s).

With respect to a shape for a drawing surface, in some cases, a single shape type is used for each drawing surface selected by drawing surface selector 108. In other cases, different drawing surfaces may correspond to different shape types. A shape type generally defines a specific geometry for a drawing surface, although drawing surface selector 108 may determine different dimensions for a geometry based on the object's size, a user's distance from the object, or other factors. A drawing surface can comprise a single shape type, but in some cases could be constructed from multiple shape types.

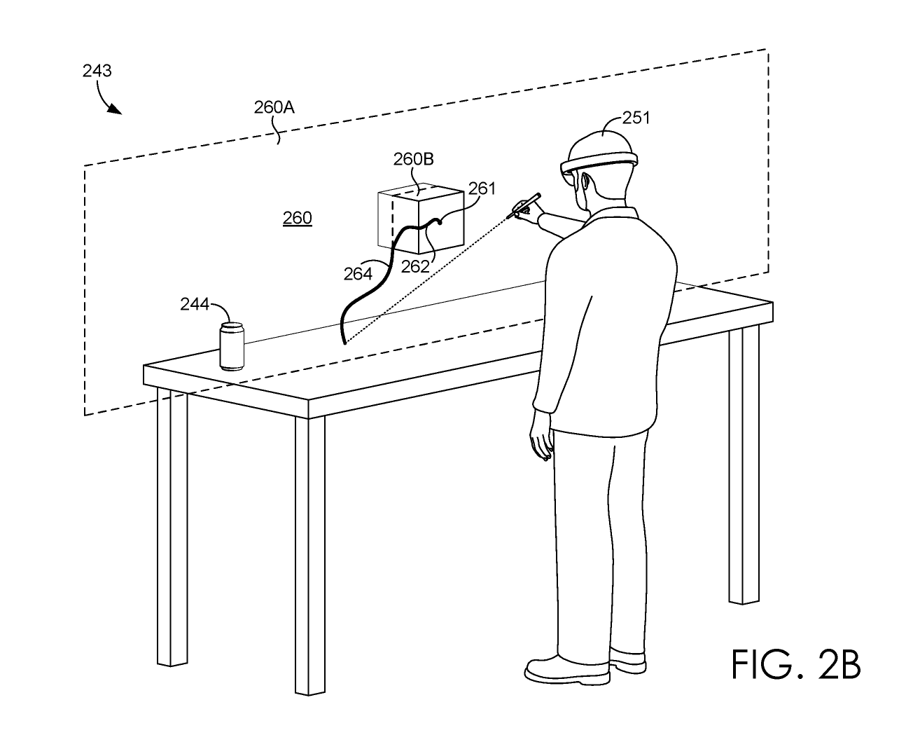

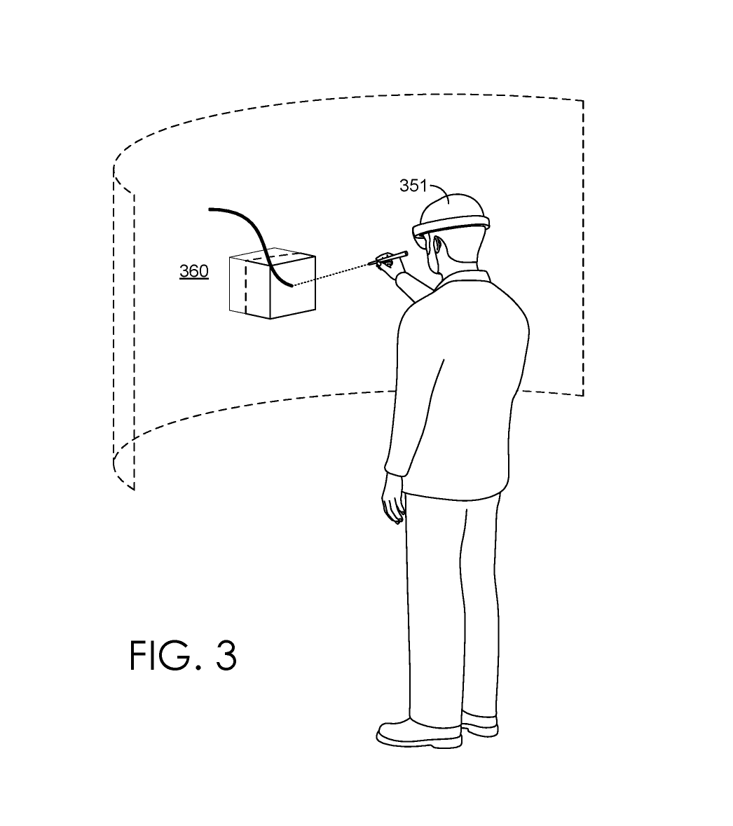

One example of a shape type for a drawing surface is a plane, such as a 2d plane. Other examples of shape types include a convex shape type and a concave shape type. A convex shape type defines a convex drawing surface and a concave shape type defines a concave drawing surface. A concave shape type can comprise a concave plane. For example, FIG. 3 shows user 351 drawing on drawing surface 360, which comprises a concave plane. Drawing surface selector 108 has determined the dimensions and anchor position of the concave plane so that as user 351 pivots his or her head, drawing surface 360 remains at a substantially constant distance from a gaze source of user 351 (e.g., the users head), such as based on a location of the user with respect to the 3D virtual reality environment. As another example, FIG. 4 shows users 451A and 451B drawing on drawing surface 460, which comprises a convex plane. Drawing surface selector 108 has determined the dimensions and anchor position of the concave plane so that drawing surface 460 is at a substantially similar distance from gaze sources of user 451A and 451B (e.g., the head or eyes), such as based on respective locations of the users with respect to the 3D virtual reality environment.

In some implementations, a shape type is a composite shape type comprising a shape of an identified object combined with another shape. For example, based on a user having selected an object, drawing surface selector 108 can merge one or more portions of the object with a reference shape, such as a 2D plane, a convex plane, a concave plane, or other shape type to generate a composite shape.

FIG. 2B shows drawing surface 260, which is an example of a drawing surface having a composite shape type. Drawing surface 260 has region 260A corresponding to a reference shape (e.g., a plane) and region 260B corresponding to a shape of object 242. Drawing surface selector 108 can generate a composite shape for drawing surface 260, for example, by combining the shapes such that at least a portion of the shape of object 242 appears to be extruded from the reference shape. In the present example, drawing surface selector 108 combines a shape of object 242 with the reference shape based on a location of a user (e.g., at least user 251), such that region 260B projects from region 260A towards the user. Also, drawing surface selector 108 can combine the shape of object 242 with the reference shape based on the orientation for the drawing surface and optionally the anchor position. In some cases, drawing surface selector 108 users the anchor position and/or orientation to determine where region 260A is to intersect region 260B with respect to object 242.

If should be appreciated that different shape types may be suitable for different use cases and/or objects. For example, where a shape for a drawing surface is generated from a shape of an object, users can draw in relation to a surface of the object, as indicated by drawing portion 262 in FIG. 2B, which follows contours of object 242. However, another shape, such as a plane may be more suitable for other user cases, such as drawing arrows to portions of an object, or otherwise annotating the object, and producing handwriting around an object. Drawing portion 264 is an example of such drawing. Implementations where a shape is based on both a shape of an object and a reference shape can advantageously leverage advantages of multiple surface shape types for drawing.

As further examples of use cases for shape types, in some cases, a concave shape type is suitable when a single user will be drawing on a drawing surface, such as is shown in FIG. 3. Also in some cases, a convex shape type is suitable when multiple users will be drawing on a drawing surface, such as is shown in FIG. 4.

In some cases, a shape type of an object is defined by metadata of the object (e.g., drawing surface selector 108 uses the shape type defined for the object). Metadata could also define characteristics of the object used to select a shape type, determine dimensions for a shape, and/or otherwise be used by drawing surface selector 108 to generate a shape for a drawing surface. In some implementations, drawing surface selector 108 selects at least one shape type for a drawing surface from one or more predefined shape types. Drawing surface selector 108 can utilize any suitable combination of factors to make such a determination including environmental understanding of the 3D virtual reality environment and/or the corresponding real world environment. To this effect, the determination may be based on the users, user profiles associated with the users, identified physical or non-physical characteristics of the users, and the like. Any of the factors of the determination could be sensed using any combination of the various sensors described herein and identified using inferences based on sensed data and/or predefined data. In other cases, a user may explicitly select a shape type or a shape type may otherwise be associated with a user input in a graphical user interface. For example, a shape type could be associated with a drawing mode selected by a user from a plurality of drawing modes. In other cases, the drawing mode may be inferred by drawing surface selector 108.

One example of a drawing mode for a drawing surface is an individual drawing mode. An individual drawing mode may be assigned a concave shape type, such as a shape type corresponding to drawing surface 360 of FIG. 3. Another example of a drawing mode for a drawing surface is a group drawing mode. A group drawing mode may be assigned a convex shape type, such as a shape type corresponding to drawing surface 460 of FIG. 4.

In some cases, drawing surface selector 108 determines which mode to enter based on determining (e.g., inferring) a number of users that will be drawing on the drawing surface. Any combination of the above factors can be employed to make such a determination, including identifying a number of users in the environment, determining one or more proximities between users, open software and/or selected features on the virtual reality device, and the like. For example, where only a single user is in an environment, drawing surface selector 108 may select an individual drawing mode. As another example, where multiple users are in an environment, drawing surface selector 108 may also select an individual drawing mode based on determining none of the other users are in close proximity (e.g., a threshold proximity) to a user initiating the drawing surface. Conversely, where only multiple users are in an environment, drawing surface selector 108 may select a group drawing mode.

With respect to a rendering mode for the drawing surface, any combination of the above factors described with respect to shape and orientation can be used to determine a render mode for a drawing surface (e.g., object metadata, inferences, and the like). A render mode for a drawing surface defines how the drawing surface is rendered in the 3D virtual reality environment and/or how drawings will be rendered on the drawing surface. This includes any combination of surface textures, shaders, colors, transparency levels, opacities, and the like. Further, certain regions of a drawing surface may have different properties than other regions. In various implementations, each drawing surface is completely transparent, such that only graphics, such as drawings on the drawing surface are perceptible to users in the 3D virtual reality environment. Thus, drawings produced on the surface may appear to float in midair while being invisibly referenced to the drawing surface. Also, in some cases, at least one visual indicator may be presented to one or more users with the 3D virtual reality environment to indicate a location(s) of the drawing surface.

Having selected a drawing surface configuration and anchor position for a drawing surface, drawing surface manager 116 can define the drawing surface in the 3D virtual reality environment at the determined anchor position with the determined drawing surface configuration. In some implementations, this includes drawing surface manager 116 creating or generating the drawing surface in the 3D virtual reality environment.

For example, in FIG. 2B, drawing surface manager 116 has defined drawing surface 260 in accordance with the anchor position and drawing surface configuration provided by drawing surface selector 108. As depicted in FIG. 2B, after the drawing surface is defined, a user may provide drawing input to a drawing interface. Drawing surface manager 116 is configured to translate the drawing input from the drawing interface into a drawing on the drawing surface. As used herein, drawing input can refer to a stream of user input. The stream of user input can track and correspond to a user's motion, such as a continuous user motion. In some cases, drawing surface manager 116 produces a drawing having a one to one correspondence with the drawing input and/or user motion, such as to mimic the user's handwriting. It is noted in some cases, smoothing, and/or other processing could be applied to the drawing input to generate drawing. In some cases, user input is converted into a graphic, such as a predefined symbol, image, or character. For example, portions of a user's handwriting or other detectable motions could be mapped to corresponding graphics. Other variations and combinations of drawing input are contemplated with embodiments of the present disclosure.

A drawing can be presented to a user in real-time, near real-time, or greater than real time as the user generate a stream of user input. In the example of FIG. 2B, the drawing input is translated to drawing in real-time, such that the user appears to be writing directly on the drawing surface.

It should be appreciated that drawing input can be generated using input device 120 and/or another input device. In the example of FIG. 2B, virtual cursor 240 is utilized to visually indicate a current location for the drawing input that moves as coordinates of the drawing input change, however a different cursor (e.g., a real cursor) could be employed or no cursor at all. Thus, it should be noted that the same or different input devices can be used to select an object as to draw on a drawing surface.

In various implementations, drawing surface manager 116 locks the drawing input to the drawing surface. Locking drawing input to a drawing surface may cause the drawing input to be referenced to the drawing surface, such that the drawing is generated and/or positioned in the 3D virtual reality environment relative to the drawing surface. In this respect, drawing on a drawing surface refers to drawing input reference to the drawing surface. However, the drawing may or more not be contacting the drawing surface or alter the drawing surface. For example, drawing surface manager 116 may reference the drawing input to a fixed distance from the drawing surface. In some cases, this includes generating the drawing at the fixed distance. In other cases, this includes confining the drawing input within a predetermined distance from the drawing surface. For example, the distance of the drawing with respect to the drawing surface could vary while being confined to the drawing surface.

In some implementations, locking drawing input to a drawing surface provides an intuitive means for users to generate drawings via user input. As an example, in some cases, where a cursor (real and/or virtual) is used to provide drawing input, a user can select an object and begin writing, without having to worry about a position of their cursor in 3D space. For example, where the cursor provides spatial input, the user can focus on 2D motions without being overly concerned with their precision in 3D space.

Various options are available for the forms of drawings generated by drawing surface manager 116. For example, one or more portions of drawings may be rendered in 2D and/or 3D. In some cases, the drawings are rendered in 2D. In other cases, the drawings are rendered in 3D. In further cases, one or more drawing portions of a drawing may initially be rendered in 2D and later converted to a 3D rendering or rendered in 3D and converted to a 2D rendering. This can occur, for example, based on detecting a release of a lock on the drawing surface, as will later be described in further detail. In addition, or instead, drawing surface manager 116 can detect a break in a stream of drawing input and perform the conversion based on the detected break. As an example, a user may draw in real-time resulting in a 2D drawing, and when the user completes the drawing, drawing surface manager 116 can convert the 2D drawing into 3D. Rendering a drawing in 3D can allow users to easily perceive the drawing in the 3D virtual reality environment from different angles and perspectives. In some cases, converting a 2D drawing to a 3D drawing includes adding a depth component to the 2D drawing. For example, a fixed depth could be added to a 2D drawing to result in a 3D drawing.

As noted above, under various conditions, a lock on drawing input may be released from a drawing surface. Releasing a lock can cause drawing input to no longer be referenced to a drawing surface. As one option, when a lock is released on a drawing surface, it can be automatically switched to another drawing surface such that drawing input is referenced to the other drawing surface. Thus, the user may continue to draw on the other drawing surface. As another option, releasing a lock may automatically switch drawing input from the locked drawing mode to a free space drawing mode. In the free space drawing mode, the drawing input may no longer be locked to any drawing surface. Further, the user may draw in free space (e.g., in real-time or near real-time).

In some cases, drawing surface manager 116 can release a lock based on an explicit or implicit selection made by a user in the graphical user interface. For example, the user could select an option to release the lock. As another example, the user could select another drawing surface to cause the lock to be switched to that drawing surface, or select free space to cause the drawing input to transition to free space. As another example, drawing surface manager 116 can release a lock based on a user pressing and/or releasing one or more trigger buttons on an input device(s). As an example, while a button is held, drawing input may be locked to a drawing surface and when released the lock may also be released.

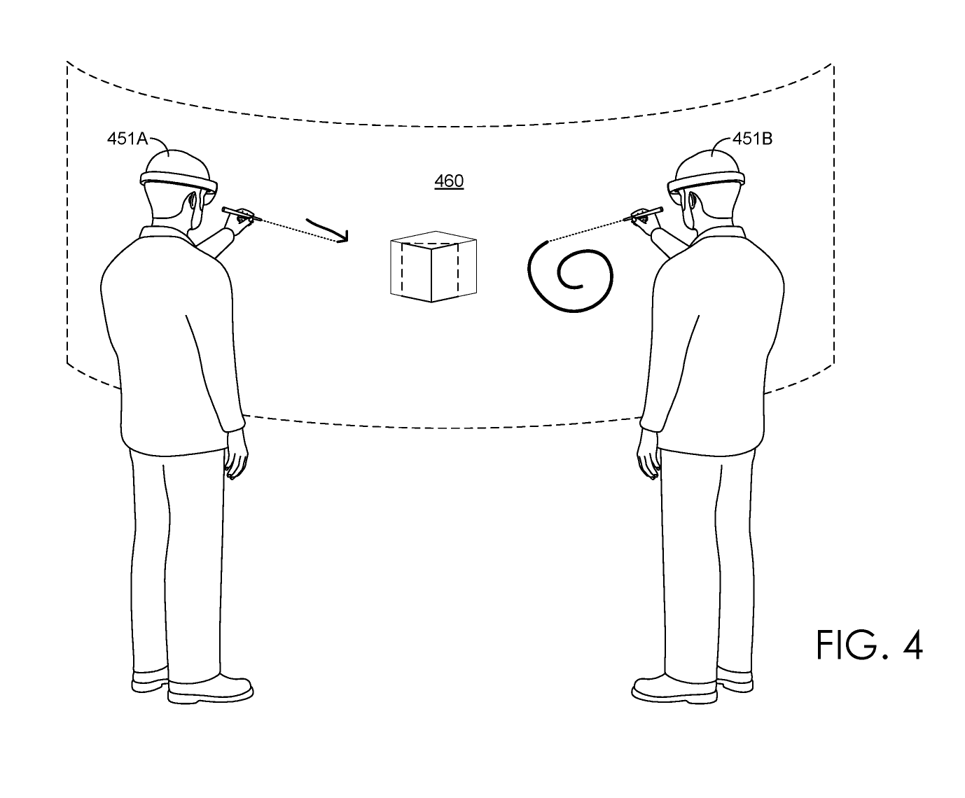

In some implementations, drawing surface manager 116 releases a lock from a drawing surface based on user input directed away from the drawing surface. FIGS. 5A, 5B, and 5C illustrate releasing a lock on a drawing surface based on user input directed away from the drawing surface, in accordance with implementations of the present disclosure. User input directed away from a drawing surface can comprise user input samples corresponding to 3D coordinates that increase in distance from the drawing surface. As examples, drawing surface manager 116 can release a lock based on user input directed away from the drawing surface by determining from one or more of the coordinates any combination of a speed, acceleration, and or a distance of the user input with respect to the drawing surface.

In the example of FIGS. 5A, 5B, and 5C, drawing surface manager 116 releases a lock based on a distance of the user input with respect to the drawing surface. In particular, drawing surface manager 116 releases the lock based on determining a coordinate of the user input is greater than threshold distance 530 from drawing surface 560. In FIG. 5A, the user has provided drawing 564 to drawing surface 560 using input device 520, which provides spatial input to the drawing interface. Subsequently, the user can move user input device 520 away from drawing surface 560 as indicated in FIG. 5A. Drawing surface manager 116 can detect user input corresponding to this motion and release the lock accordingly. In some cases, drawing surface manager 116 provides user feedback as a user approaches threshold distance 530. The user feedback can comprise any combination of haptic feedback, visual feedback, and audible feedback. The feedback may be generated, for example, by feedback generator 128 and/or a feedback generator of HMD 104. In some cases, at least some of the user feedback changes based on the distance of from the drawing surface. As the distance approaches threshold distance 530, for example, the user feedback may intensify or otherwise indicate proximity to threshold distance 530. This can include increasing volume of audible feedback or increasing vibration in haptic feedback, changing a color of visual feedback, and the like.

In the example, of FIG. 5B, based on threshold distance 530 being exceeded, drawing surface manager 116 transitions to free space drawing mode. As shown, the user has provided drawing 566 via drawing input generated in the free space drawing mode. The user may return to a locked drawing mode using any suitable approach, such as by selecting drawing surface 560 and/or object 542 (e.g., similar to how the user selected object 542 to define drawing surface 560).

In the example, of FIG. 5C, based on threshold distance 530 being exceeded, drawing surface manager 116 transitions the locked drawing mode from drawing surface 560 to drawing surface 562. As shown, the user has provided drawing 568 via drawing input generated while the drawing input is locked to drawing surface 562. Drawing surface 562 may have been defined using a similar method as drawing surface 560. In other cases, a different method is employed. For example, drawing surface 560 may not be defined based on any particular object. In some cases, drawing surface 562 is generated based on drawing surface 560, such as based on drawing surface manager 116 detecting threshold distance 530 is exceeded. In some implementations, drawing surface 562 exists prior to drawing surface 560 and/or drawing 564. Further drawing surface 562 could have similarly preexisting drawing 570. The user may return to being locked to drawing surface 560 using any suitable approach, such as by selecting drawing surface 560 and/or object 542 (e.g., similar to how the user selected object 542 to define drawing surface 560). In another approach, threshold distance 532 can be used similar to threshold distance 530.

When transitioning to a lock on a different drawing surface, drawing surface manager 116 may select a new drawing surface nearest to the drawing surface in the direction of the user input, as one example. As another example, the user could be prompted to select the new drawing surface. In addition, or instead, the new drawing surface could be determined based on a gaze direction of the user.

Although implementations have been described with respect to selection of an object based on user input, in other cases, the drawing surface can be defined without respect to a particular object. It should therefore be appreciated that defining the drawing surface may be accomplished using any suitable manner. Further, concepts described herein extend beyond drawing and descriptions of drawing can also apply more generally to user defined graphics compositions, which may include placement of digital stickers, decals, stamps, text, and other graphics a user can position to define a graphical composition, in addition to or instead of the drawing.

In some implementations, at least while drawing input is locked to a drawing surface, the orientation of the drawing surface with respect to the 3D virtual reality environment remains fixed. Thus, the orientation could be independent from the location of users in the 3D virtual reality environment. In other cases, the orientation could change, such as based on the gaze direction and/or location of at least one user. As an example, the orientation could change so the drawing surface remains facing the user as the user moves around and/or looks around the environment. It is noted, in cases where the orientation of the drawing surface changes, any drawings on the drawing surface can similarly change orientation with the drawing surface.

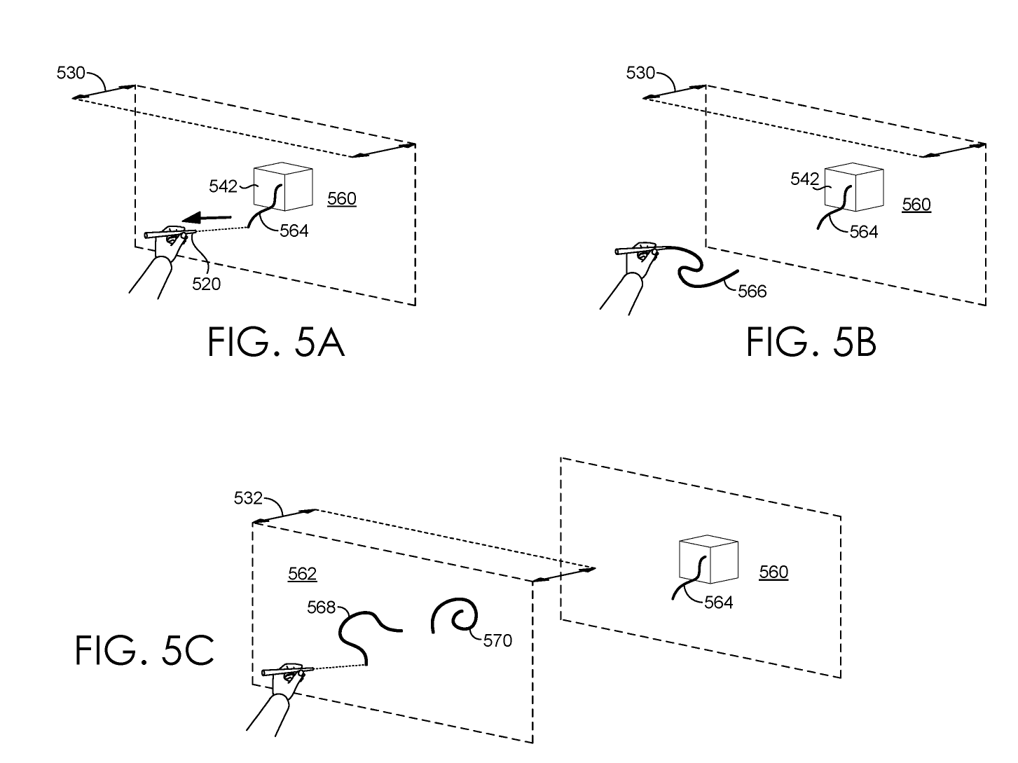

With reference to FIG. 6, a method for drawing in a 3D virtual reality environment is provided. In some embodiments, method 600 is performed using the integrated free space and surface input system described herein. Block 610 includes identifying an intersection between user input and an object. For example, HMD 104 can identify an intersection between user input corresponding to casted user input 246 and object 242 associated with three-dimensional (3D) virtual reality environment 243 using casting unit 112.

Block 620 includes determining an anchor position for a drawing surface based on the intersection. For example, HMD 104 can determine anchor position 261 for drawing surface 260 based on the determined intersection.

Block 630 includes identifying a gaze direction of user. For example, HMD 104 can utilize gaze identifier 114 to identify gaze direction 250 of user 251.

Block 640 includes determining a drawing surface configuration based on the gaze direction. The drawing surface configuration can indicate how the drawing surface is defined in the 3D virtual reality environment. For example, drawing surface selector 108 can determine one of drawing surface configurations 110 based on the gaze direction. This can include at least determining an orientation for the drawing surface based on gaze direction 250.

Block 650 includes defining the drawing surface at the anchor position with the drawing configuration. For example, drawing surface manager 116 can define drawing surface 260 at anchor position 261 having the orientation shown in FIG. 2B.

Block 660 includes generating a drawing on the defined drawing surface. For example, drawing surface manager 116 can generate drawing portions 262 and 264 based on drawing input from input device 120. It is noted that any combination of blocks 620, 630, 640, and 650 can be performed automatically in response to block 610, and in some cases without active or explicit user input. In some cases, upon completion of block 650, the user is automatically locked to the drawing surface and can begin providing the drawing input. For example, drawing surface manager 116 could automatically being receiving drawing input and generating a drawing. Thus, a user may direct user input to an object, and may begin drawing on the drawing surface without a perceptible delay. This and other approaches are contemplated as being with the scope of the present disclosure.

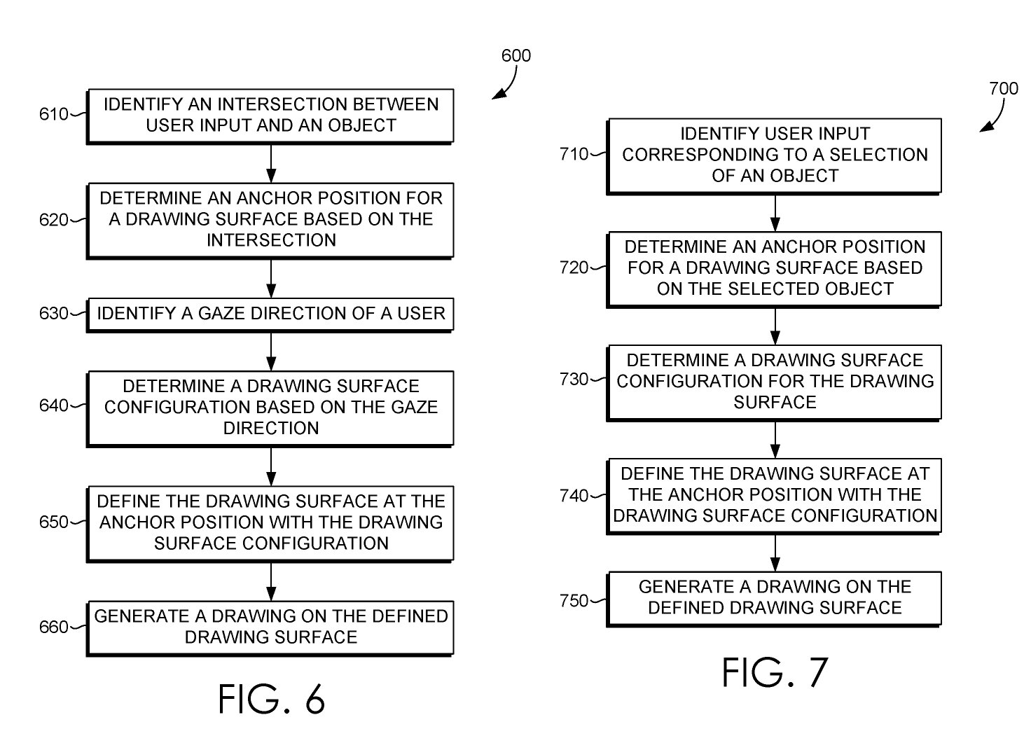

With reference to FIG. 7, drawing in a 3D virtual reality environment is provided. A computer storage medium can include computer-executable instructions that when executed by a processor causes the processor to perform the method. In some cases, method 700 is performed using the integrated free space and surface input system described herein.

Block 710 includes user input corresponding to a selection of an object. Block 720 includes determining an anchor position for a drawing surface based on the selected object. Block 730 includes determining a drawing surface configuration for the drawing surface. Block 740 includes defining the drawing surface at the anchor position with the drawing surface configuration. Block 750 includes generating a drawing on the defined drawing surface.

Turning to FIG. 8, the HMD device 802 having the integrated free space and surface input mechanism 840 is described in accordance with an embodiment described herein. The HMD device 802 includes a see-through lens 811 which is placed in front of a user's eye 814, similar to an eyeglass lens. It is contemplated that a pair of see-through lenses 811 can be provided, one for each eye 814. The lens 811 includes an optical display component 828, such as a beam splitter (e.g., a half-silvered mirror). The HMD device 802 includes an augmented reality emitter 830 that facilitates projecting or rendering the of augmented reality images. Amongst other components not shown, the HMD device also includes a processor 842, memory 844, interface 846, a bus 848, and additional HMD components 850. The augmented reality emitter 830 emits light representing a virtual image 820 exemplified by a light ray 808. Light from the real-world scene 804, such as a light ray 806, reaches the lens 811. Additional optics can be used to refocus the virtual image 820 so that it appears to originate from several feet away from the eye 814 rather than one inch away, where the display component 828 actually is. The memory 844 can contain instructions which are executed by the processor 842 to enable the augmented reality emitter 830 to perform functions as described. One or more of the processors can be considered to be control circuits. The augmented reality emitter communicates with the additional HMD components 850 using the bus 848 and other suitable communication paths.

A light ray representing the virtual image 820 is reflected by the display component 828 toward a user's eye, as exemplified by a light ray 810, so that the user sees an image 812. In the augmented-reality image 812, a portion of the real-world scene 804, such as, a cooking oven is visible along with the entire virtual image 820 such as a recipe book icon. The user can therefore see a mixed-reality or augmented-reality image 812 in which the recipe book icon is hanging in front of the cooking oven in this example.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Having described embodiments of the present invention, an exemplary operating environment in which embodiments of the present invention may be implemented is described below in order to provide a general context for various aspects of the present invention. Referring initially to FIG. 9 in particular, an exemplary operating environment for implementing embodiments of the present invention is shown and designated generally as computing device 900. Computing device 900 is but one example of a suitable computing environment and is not intended to suggest any limitation as to the scope of use or functionality of the invention. Neither should the computing device 900 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 9, computing device 900 includes a bus 910 that directly or indirectly couples the following devices: memory 912, one or more processors 914, one or more presentation components 916, input/output ports 918, input/output components 920, and an illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 9 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a head-mounted display device as an augmented reality device; however the head-mounted display device depicted herein is merely exemplary. Components can be configured for performing novel aspects of embodiments, where configured for comprises programmed to perform particular tasks or implement particular abstract data types using code. Further, while embodiments of the present invention may generally refer to the head-mounted display device and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

1. A computer-implemented method comprising:
identifying an intersection between a user input and an object associated with a three-dimensional (3D) virtual reality environment;
determining an anchor position for a drawing surface based on the identified intersection;
identifying a gaze direction of a user in the 3D virtual reality environment;
determining a drawing surface configuration for the drawing surface with respect to the 3D virtual reality environment based on the gaze direction, wherein the drawing surface configuration indicates how the drawing surface is defined in the 3D virtual reality environment;
defining the drawing surface in the 3D virtual reality environment at the determined anchor position with the determined drawing surface configuration;
receiving drawing input from a drawing interface; and
rendering a drawing on the drawing surface based on the received drawing input.

2. The computer-implemented method of claim 1, wherein the identifying of the intersection comprises:
casting the user input in the 3D virtual reality environment; and
detecting a collision between the casted user input and the object.

3. The computer-implemented method of claim 1, wherein the determining of the drawing surface configuration comprises determining an orientation for the drawing surface in the 3D virtual reality environment based on the gaze direction.

4. The computer-implemented method of claim 1, wherein the object corresponds to a real object in a real world environment, and the identifying of the user input corresponding to the selection of the object comprises detecting the real object in the real world environment.

5. The computer-implemented method of claim 1, wherein the user input and the drawing input are generated by a common input device.

6. A computer-implemented system comprising:
one or more processors; and
one or more computer storage media storing computer-useable instructions that, when executed by the one or more processors, cause the one or more processors to perform a method comprising:
identifying user input corresponding to a selection of an object associated with a three-dimensional (3D) virtual reality environment;
determining an anchor position for a drawing surface based on the selected object;
determining a drawing surface configuration for the drawing surface with respect to the 3D virtual reality environment, wherein the drawing surface configuration indicates how the drawing surface is defined in the 3D virtual reality environment;
defining the drawing surface in the 3D virtual reality environment at the determined anchor position with the determined drawing surface configuration; and
receiving drawing input from a drawing interface; and
rendering a drawing on the drawing surface based on the received drawing input.

7. The computer-implemented system of claim 6, further comprising in response to detecting spatial input directed away from the drawing surface in the 3D virtual reality environment, terminating the rendering of the drawing on the drawing surface.

8. The computer-implemented system of claim 6, further comprising in response to detecting spatial input directed away from the drawing surface in the 3D virtual reality environment, switching from a locked drawing mode to a free space drawing mode.

9. The computer-implemented system of claim 6, further comprising in response to detecting spatial input directed away from the drawing surface in the 3D virtual reality environment, switching a lock on drawing input from the drawing surface to another drawing surface in the 3D virtual reality environment.

10. The computer-implemented system of claim 6, presenting user feedback based on spatial input directing a cursor away from the drawing surface in the 3D virtual reality environment and based on a distance between a cursor and the drawing surface.

11. The computer-implemented system of claim 6, wherein the determining of the drawing surface configuration comprises selecting a concave shape type for the drawing surface from a plurality of shape types.

12. The computer-implemented system of claim 6, wherein the determining of the drawing surface configuration comprises selecting a convex shape type for the drawing surface from a plurality of shape types.

13. The computer-implemented system of claim 6, wherein the determining of the drawing surface configuration comprises generating a composite shape type for the drawing surface from a shape of the object and a reference shape type.

14. The computer-implemented system of claim 6, wherein the determining of the drawing surface configuration comprises selecting a shape type for the drawing surface based on determining whether the drawing surface is for an accompanied mode for drawing or a solo mode for drawing, the accompanied mode corresponding to a first shape type and the solo mode corresponding to a second shape type.

15. The computer-implemented system of claim 6, wherein the selection of the object corresponds to user input from a cursor controlled by a user.

16. The computer-implemented system of claim 6, wherein the drawing input comprises a stream of user input corresponding to a continuous user motion.

17. One or more computer storage media storing computer-useable instructions that, when executed by one or more processors, cause the one or more processors to perform a method comprising:
identifying user input corresponding to a selection of an object associated with a three-dimensional (3D) virtual reality environment;
determining an anchor position for a drawing surface based on the selected object;
determining a drawing surface configuration for the drawing surface with respect to the 3D environment, wherein the drawing surface configuration indicates how the drawing surface is defined in the 3D virtual reality environment;
defining the drawing surface in the 3D virtual reality environment at the determined anchor position with the determined drawing surface configuration;
receiving drawing input from a drawing interface; and
rendering a drawing on the drawing surface based on the received drawing input.

17. (canceled)

18. The one or more computer storage media of claim 17, further comprising in response to detecting spatial input directed away from the drawing surface in the 3D virtual reality environment, switching from a locked drawing mode to a free space drawing mode.

19. The one or more computer storage media of claim 17, further comprising in response to detecting spatial input directed away from the drawing surface in the 3D virtual reality environment, switching a lock on drawing input from the drawing surface to another drawing surface in the 3D virtual reality environment.

20. The one or more computer storage media of claim 17, further comprising identifying a gaze direction of a user in the 3D virtual reality environment, wherein the determining the drawing surface configuration for the drawing surface with respect to the 3D virtual reality environment is based on the gaze direction.
